(19) United States
(12) Patent Application Publication
(10) Pub. No.: US 2004/0019856 A1
(43) Pub. Date: Jan. 29, 2004

(54) Numeric coding method

(76) Inventors: Bruce Hamilton, Menlo Park, CA (US); Jerry J. Liu, Sunnyvale, CA (US); Jefferson B. Burch, Palo Alto, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/202,932

(22) Filed: Jul. 25, 2002

(51) Int. Cl. G06F 17/00

(52) U.S. Cl. 715/531

(57) ABSTRACT

Coding numeric values into text. Uncertainty metadata kept with stored values is used to facilitate numeric-to-text conversion. Using uncertainty associated with values, only meaningful mantissa digits are returned. Excess information is trimmed to reduce transmission times.

### BACKGROUND OF THE INVENTION

1. Field of the Invention

The present invention deals with computer software for formatting floating point numbers as text, particularly when such numbers must be sent across networks.

2. Art Background

A common problem faced in transferring numeric data such as with XML and many databases over networks is that they require information which is stored in a binary floating point representation to be sent out as text, either ASCII or Unicode. Since this information is often sent over low bandwidth networks, the extra space required by sending it as text incurs extra transmission time.

An additional issue arises with the interpretation and uncertainty in numerical measurements. For example, the precision with which a value can be represented in a binary floating point form is determined by the storage type, e.g. 7 digits for a single-precision value, and 15 digits for a double-precision value. Standard routines for converting from binary floating point to text usually produce the full length text result, for example yielding 7 or 15 digits for single or double-precision values. Yet the “precision” given by many of these digits may be spurious or illusory. For example, consider a temperature sensor with a specified ½ degree C. accuracy. If the output of this sensor is digitized, stored as a single-precision floating-point value, converted to a degrees Fahrenheit value and displayed as text, a result such as 97.44354 may be produced. Such a result implies far more accuracy than exists in the transducer, and takes longer to transmit over a network.

### SUMMARY OF THE INVENTION

Uncertainty metadata associated with binary floating point quantities is used to facilitate the number-to-text encoding process. Uncertainty associated with a binary floating point quantity is used to provide only as many mantissa digits as are meaningful. Excess information is trimmed to reduce transmission times.

### BRIEF DESCRIPTION OF THE DRAWINGS

The present invention is described with respect to particular exemplary embodiments thereof and reference is made to the drawings in which:

FIG. 1 is a flowchart of the coding method.

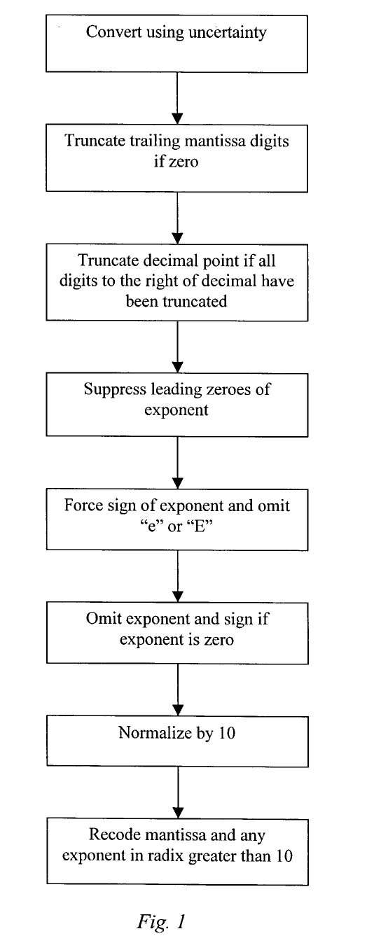

### DETAILED DESCRIPTION

A common problem faced in transferring numeric data over networks, for example database or sensor information transmitted using XML, is that numeric data stored in a binary floating-point format must be sent out as text, either ASCII or Unicode. Methods of converting data stored in binary floating point format to text are well known in the art.

The precision with which a binary floating point value can be represented is determined by the storage type. e.g. 7 decimal digits for a single-precision value, and 15 digits for a double-precision value. A well known standard for binary floating point arithmetic is the IEEE 754 standard.

A common approach to converting binary floating point values to text is via the “f” format supported by languages such as Fortran and C. The “f” format, e.g. “%0.8f” as used in standard I/O libraries used with the C language provides spurious precision in some cases, for example representing the value 45.67 as “45.67000000”; and provides too little precision in other cases, for example representing 4.567×10⁻⁷ as “0.00000045.”

Since standard ASCII characters occupy one byte of storage and Unicode characters require two bytes of storage, character strings in this application are discussed in terms of character length rather than bytes.

For values stored in single-precision floating point, using scientific notation, where numbers are expressed in text in the form “[−]m.nnnnnne[+−]xx” where the length of the string of n's is specified by the precision and xx is the exponent, “%0.6e” avoids truncating significant digits, and produces only as many characters as is appropriate for a single-precision floating point storage type. For values stored in double-precision format, “%0.14e” achieves the same result. For example, using “%0.6e” produces “4.567000e+01” for 4.567 stored as a single-precision number, and using “%0.14c” produces “4.56700000000000e-07” for 4.567×10⁻⁷ stored as a double-precision number. While positive single-precision floating point numbers are used as examples, the present invention is equally applicable to positive and negative values, and to multiple precision formats.

The present invention makes use of uncertainty information associated with a value to drive the number-to-text conversion process. Uncertainty of a value is different from the finite precision which results from the choice of storage type, e.g. 7 digits for a single-precision floating point value and 15 digits for a double-precision floating point value. Uncertainty arises from limitations in measurement components and method. It is nearly always greater than the uncertainty introduced by conversion to a floating-point format. For example, while a temperature value may be stored as a single-precision floating point value allowing up to 7 digits of precision, the combination of the temperature sensor used and the conversion process for quantizing the temperature sensor value may result in an uncertainty of 0.1 degrees C. Uncertainty information is sometimes available from the context (e.g. local knowledge of the transducer or environment) and sometimes available explicitly (e.g. it is a required element in data records conforming to the IEEE 1451.2 standard).

Converting the floating point value 45.67 to text using a standard scientific “%0.6e” format produces a 12 character string “4.567000e+01”.

The present invention makes use of the uncertainty associated with the value to be converted, according to the following steps:

Step 1: Using the uncertainty associated with the value to be converted, provide only as many mantissa digits as are meaningful, rounding off at the last meaningful digit. For example, if the uncertainty associated with the value 45.67 is 0.1, the converted text is “4.57e+01” which is 8 characters in length, a substantial savings over the 12 characters generated by a standard “%0.6e” format. Because the result is driven by the uncertainty, precision in the converted value is not concealed. Note that this step may save computing time as well as transmission time. All subsequent steps in the process spend computing time to save transmission time, which is usually a good tradeoff.

A user or organization wishing to preserve more precision and willing to spend more space and time could round to 1/10 of the uncertainty, 1/100, etc. Similarly, one wishing to compress more aggressively and willing to sacrifice precision could round at 10× the uncertainty, etc This is equivalent to scaling the uncertainty by a factor of 10ⁿ where n is an integer. Suppose that the value in question has x significant digits and the storage type used for the value has y significant digits. Scaling by x (i.e. rounding at 10^{x}) would remove all the significance, and scaling by x-y would pretend that the entire value was significant. The preferred range for scaling by n is therefore from x-y to x. As an example, assume a quantity has 4 significant digits (x=4) and the storage type provides for 7 digits (y=7). Scaling the uncertainty by a factor of x-y, 4−7=−3, would return all 7 digits.

While rounding is traditionally discussed in terms of whole-digit values, e.g. rounding 4.56 to 4.6, rounding to other values is equally valid mathematically. For example, a value might be 98.765 plus or minus 6.23. In that case the value 98.765 is rounded to the nearest 6.23, displaying 99.68.

A first embodiment of this step converts only as many digits as are needed for the specified uncertainty, rounding off the last meaningful digit. A second embodiment of this step uses standard number-to-text libraries, such as those provided by the C language STDIO library. For example, the STDIO function sprintf is first used to convert the value to a string using the “e” format to produce a string with the full precision available for the storage type used. Using the uncertainty associated with the value, the mantissa portion of the text string s rounded and truncated to the required length.

Step 2: Truncate trailing mantissa digits if they are zero. For example, if the value 45.67 were converted according to Step 1 with an uncertainty of 0.001, the string “4.5670e+01” would result. This step would send “4.567e+01” instead.

Step 3: If all digits to the right of the decimal point have been truncated, truncate the decimal point.

Step 4: Suppress leading zeroes in the exponent.

Steps 1 through 4 produce character strings which will be recognized as valid numeric values by a wide range of standard software. Such software includes applications such as spreadsheets and databases. The following steps achieve additional savings at the cost of requiring the receiving software to recognize and deal with possibly nonstandard formats. Applications communicating using XML typically have an opportunity to manipulate the results of XML parsing, allowing the following steps to be used:

Step 5: Always provide the sign of the exponent (some conversion libraries suppress the sign if it is “+”) but omit the exponent character, “e” or “E” depending on the library or formatting string used. This saves a character when the exponent is negative and avoids ambiguities with later steps. This step produces “4.567+1” for 45.67 and “4.567−7” for 4.567×10⁻⁷.

Step 6: If the exponent is zero, omit both it and its sign. Step 7: Normalize by 10. Shift the decimal point to the front of the string by dividing the mantissa by 10 and adding 1 to the exponent, then re-applying step 6. Knowing that we now have a leading decimal point, we can now suppress it, leaving a mantissa which is effectively an integer. The exponent is already an integer. The value 45.67 thus becomes “456730 2”.

Step 8: Represent both mantissa and exponent in hexadecimal, using approximately ⅝ as many characters. As an alternative, a larger radix could be used. For example, a base 62 encoding using the character ranges “0”- “9”, “a”- “z”, and “A”-“Z” would reduce the width of numbers on average to 16% of their original (decimal radix) size.

Applying these steps to the value 12.34 with uncertainty 0.001 produces the following:

| | | |
|---|---|---|
| “1.234000e+01” | 12 characters | “%.6e” format |
| “1.2340e+01” | 10 characters | Step 1 |
| “1.234E+01” | 9 characters | Step 2 |
| “1.234E+01” | 9 characters | Step 3 |
| “1.234E+1” | 8 characters | Step 4 |
| “1.234 + 1” | 7 characters | Step 5 |
| “1234 + 1” | 7 characters | Step 6 |
| “1234 + 2” | 6 characters | Step 7 |
| “4d2 + 2” | 5 characters | Step 8 |

These steps in accordance with the present invention can provide significant savings. Assume that noise and rounding errors have provided a value such as 4.00000043819. If the uncertainty associated with this value is 0.00001, then applying the specified steps results in the string “4+1”.

Note that while the examples given have been in terms of positive numbers, negative numbers are processed by dealing with their absolute value and prepending a minus sign to the resulting character string.

The foregoing detailed description of the present invention is provided for the purpose of illustration and is not intended to be exhaustive or to limit the invention to the precise embodiments disclosed. Accordingly the scope of the present invention is defined by the appended claims.

We claim:

1. A method of converting a binary floating point number represented in a specified storage type to text comprising:
associating an uncertainty value with a binary floating point number, and
returning as text only as many digits as needed for the specified uncertainty.

2. The method of claim 1 where the step of returning as text only as many digits as needed for the specified uncertainty further comprises:
using a standard library function to convert the number to text in scientific notation, and
using the uncertainty value to round and truncate the text string to the length required by the uncertainty value.

3. The method of claim 1 where the step of returning as text only as many digits as needed for the specified uncertainty further comprises:
converting only as many digits to text in scientific notation as are needed for the specified uncertainty, rounding off the last meaningful digit.

4. The method of claim 1 where the uncertainty value is scaled by a factor of 10ⁿ, where n is an integer in the range x-y to x, where x is the number of significant digits and y is the number of digits provided by the storage type for the value.

5. The method of claim 1 further including the step of truncating trailing mantissa digits in the text if the trailing mantissa digits are zero.

6. The method of claim 5 further including the step of truncating the decimal point in the text if all digits to the right of the decimal point have been truncated.

7. The method of claim 6 further including the step of suppressing leading zeroes in the text portion of the exponent.

8. The method of claim 7 further including the step of providing the sign of the exponent and removing the exponent character (“e” or “E”) from the text.

9. The method of claim 8 further including the step of removing the exponent and its sign from the text if the exponent is zero.

10. The method of claim 9 further including the step of normalizing by ten and suppressing the leading decimal point.

11. The method of claim 10 further including the step of recoding the mantissa and any exponent in a radix other than 10.

12. The method of claim 11 where the radix is 16.

13. The method of claim 11 where the radix is greater than 16.

14. A computer readable medium carrying one or more sequences of instructions from a user of a computer system for converting a binary floating point value to text, wherein execution of the one or more sequences of instructions by one or more processors causes the one or more processors to perform the steps of:
associating an uncertainty value with the binary floating point value, and
converting to text only as many digits as are needed for the specified uncertainty.

15. The computer readable medium of claim 14 where the step of converting to text only as many digits as needed for the specified uncertainty further comprises:
using a standard library function to convert the number to text in scientific notation, and
using the uncertainty value to round and truncate the text string to the length required by the uncertainty value.

16. The computer readable medium of claim 14 where the stop of converting to text only as many digits as needed for the specified uncertainty further comprises:
converting only as many digits to text in scientific notation as are needed for the specified uncertainty, rounding off the last meaningful digit.
